(19) United States
(12) Patent Application Publication
(10) Pub. No.: US 2024/0367138 A1
(43) Pub. Date: Nov. 7, 2024

(54) DISTRIBUTED NON-EQUILIBRIUM CHEMICAL AND MATERIAL SYNTHESIS USING COMBINED PLASMA ACTIVATION AND PROGRAMED HEATING AND QUENCHING

(71) Applicants: THE TRUSTEES OF PRINCETON UNIVERSITY, Princeton, NJ (US); UNIVERSITY OF MARYLAND, COLLEGE PARK, College Park, MD (US)

(72) Inventors: Yiguang JU, Princeton, NJ (US); Liangbing HU, Potomac, MD (US)

(73) Assignees: The Trustees of Princeton University, Princeton, NJ (US); University of Maryland, College Park, College Park, MD (US)

(21) Appl. No.: 18/284,573

(22) PCT Filed: Mar. 31, 2022
(86) PCT No.: PCT/US2022/022829

§ 371 Date: Sep. 28, 2023

Related U.S. Application Data
(60) Provisional application No. 63/169,310, filed on Apr. 1, 2021.

(51) Int. Cl. B01J 19/08; B01J 19/00; B01J 21/18; B01J 23/00; B01J 35/33

(52) U.S. Cl. CPC B01J 19/088; B01J 19/0013; B01J 21/18; B01J 23/002; B01J 35/33; B01J 2219/0801; B01J 2219/0869; B01J 2219/0871; B01J 2219/0892; B01J 2219/0896

(57) ABSTRACT

The approach disclosed herein is a process for non-equilibrium chemical and materials processing using the combination of non-equilibrium plasma, non-equilibrium multi-functional catalysis, a precisely programed heating and quenching (PHQ), and supersonic reaction quenching to dynamically change the chemical equilibrium and increase the yield and selectivity of the products. An important feature of the disclosed approach is to realize an efficient and high selectivity synthesis method of chemicals and materials by using non-chemical equilibrium, non-equilibrium catalysts, and non-equilibrium of excited states via active control of molecule excitation by low temperature hybrid plasma, dynamics of chemical reactions by programed heating and supersonic quenching, and the design of non-equilibrium catalysts by thermal shocks and plasma coupling to enable distributed and electrified chemical synthesis of hydrogen, ammonia, valued carbon and other chemical products at atmospheric conditions. As such, the disclosed approach will enable distributed, electrified, low-carbon, and non-equilibrium chemical and material synthesis using renewable electricity, fossil fuels, biomass, and other abundant or waste resources.

### CROSS-REFERENCE TO RELATED APPLICATIONS

This application claims priority to U.S. Provisional Patent Application 63/169,310, filed Apr. 1, 2021, the entirety of which is incorporated by reference herein.

### STATEMENT REGARDING FEDERALLY SPONSORED RESEARCH OR DEVELOPMENT

This invention was made with government support under Grant Nos. DE-FE0026825 and DE-SC0020233 awarded by the Department of Energy. The government has certain rights in the invention.

### BACKGROUND

One of the increasing concerns of climate change requires immediate action to reduce CO₂ emissions from directly burning fossil fuels. At the same time, the recent increase of renewable electricity and the need of large-scale electricity storage provide a great opportunity to produce valuable chemicals and materials such as fuels, ammonia, hydrogen, and valuable carbon from natural gas, biomass, water, CO₂, and other abundant and waste resources by taking advantage of its abundant resource.

The predominant commercial method for production of hydrogen and carbon from natural gas is the high temperature thermal cracking process. However, the thermal cracking method has low yield and produces less valuable carbon but large amounts of polluting emissions (e.g., CO₂ and NOₓ). The predominant commercial method to produce ammonia is the Haber-Bosch process using nitrogen and hydrogen. However, this process is based on the thermal chemical equilibrium catalysis and requires high temperature and high pressure (100-300 atm) and is very energy and carbon intensive.

With the availability of excess renewable electricity at peak hours, an environmentally benign plasma synthesis method for fuels, ammonia, hydrogen, and valuable carbon production has become very attractive. The electrical heating and plasma synthesis methods are free from pollutant emissions and its theoretical yield can reach 100% by using a non-equilibrium kinetic process. However, due to the poor understanding of transient electrical heating and plasma chemistry in the electrified chemical synthesis method, current yields of existing electric and plasma reactors are far below the theoretical limit.

Therefore, systems and methods for increase the yield and selectivity of controlled electrical heating and plasma synthesis are useful and desirable.

### BRIEF SUMMARY

A first aspect of the present disclosure is drawn to a method for non-equilibrium chemical and materials processing. The method may include providing a fluid comprising a first material to a reaction chamber, generating a non-equilibrium low temperature plasma at a first temperature, forming a second material by allowing the first material to react in the reaction chamber at a second temperature, the second temperature being a temperature pulse created by programmed electrical heating in at least part of the non-equilibrium low temperature plasma, and quenching the second material in a supersonic nozzle. The non-equilibrium low temperature plasma may be generated with or without programmed electrical heating. The quenching may occur with or without additional plasma discharge.

In various embodiments, the first material may be configured to react with a non-equilibrium multifunctional plasma catalyst in the reaction chamber, the non-equilibrium multifunctional plasma catalyst configured to the selectivity and yield via the increase of the active catalyst sites and the coordination between plasma and catalysts. In some embodiments, the non-equilibrium multifunctional plasma catalyst may be a bimetallic non-equilibrium catalyst (such as Ni, Co, Cu, Ru, Pt, Fe, or a combination thereof), which may be used to produce surface charge and enhanced electric field. In some embodiments, the bimetallic non-equilibrium catalysts may include ferroelectric perovskite catalysts, which may have an ABO; structure (where A and B are appropriate cations). In some embodiments, the non-equilibrium multifunctional plasma catalyst may be a plasmonic nanocatalyst (such as Au, Ag, Cu, Ru, or a combination thereof), which may be used to create a plasmon enhanced electric field and plasmon enhanced catalysis.

In some embodiments, the synthesis temperature is controlled such that the non-equilibrium catalysts will not agglomerate and lose active interfaces and sites at the synthesis temperature. In some embodiments, the method may include dynamically adjusting the synthesis temperature and time.

A second aspect of the present disclosure is a system for non-equilibrium chemical and materials processing.

The system may include a reaction chamber operably couplable to a source of a first material. The reaction chamber may include a nano-second discharge (NSD) electrode, a programmed pulse electrical heater (which may include a plurality of electrodes), and a supersonic quenching nozzle. The system may include a controller configured to generate a non-equilibrium plasma and utilize the programmed pulse electrical heater to control the temperature time history in the downstream of the NSD to allow the first material to react and form a second material in a non-equilibrium process, after which the product materials is quenched as it passes through the supersonic quenching nozzle. In some embodiments, the non-equilibrium plasma may be generated by a nano-second discharge at the NSD electrode.

In some embodiments, a non-equilibrium multifunctional plasma catalyst may be present in the reaction chamber. In some embodiments, a plurality of carbon fibers supports a non-equilibrium multifunctional plasma catalyst within the reaction chamber and provide temporal and spatial control of temperature.

### BRIEF DESCRIPTION OF DRAWINGS

FIG. 1 is a flowchart of an embodiment of a method.

FIG. 2 is a simplified block schematic of an embodiment of a reactor.

FIG. 3 is a cross-section of an embodiment of a portion of reactor.

FIGS. 4A and 4B are cross-sections of embodiments of the nozzle portion of a reactor.

FIGS. 5A and 5B are graphs showing voltages over time in an embodiment of a system where Pₘₑₐₙ=2 kV (FIG. 5A) and Pₚₑₐₖ=150 kV (FIG. 5B).

FIG. 6A is a graph showing the temperature profile of an embodiment of a system.

FIG. 6B is a graph showing a comparison of catalytic methane conversion using an embodiment of the method vs a traditional equilibrium conversion.

FIG. 7 is a graph illustrating voltage and current pulse profile in a discharge in an embodiment of the system.

### DETAILED DESCRIPTION

Existing methods in chemicals and materials synthesis often use a chemical equilibrium process that requires high temperature, high pressure, and fossil fuel heating. As a result, this process is very energy intensive and produces a lot of carbon emissions. In addition, due to constraints of high pressure and temperature, the chemical reactors are too large to be scaled down for distributed chemical processing under atmospheric pressure. Furthermore, due to chemical equilibrium processing, the yield and selectivity of the process are constrained by chemical equilibrium. As such, at low temperature and/or low pressure, the synthesis rate is very low. On the other hand, at high temperature, only the equilibrium catalysts can be used. Therefore, the selectivity and yield are limited by the performance of equilibrium catalysts. Furthermore, at high temperature, coke formation from the pyrolysis of fossil fuels causes serious problem of the loss of active catalyst sites.

The approach disclosed herein is a process for non-equilibrium chemical and materials processing using the combination of non-equilibrium plasma, non-equilibrium multi-functional catalysts, a precisely programmed heating and quenching (PHQ), and supersonic reaction quenching to dynamically change the chemical equilibrium and increase the yield and selectivity of the products via non-equilibrium chemical synthesis.

The disclosed approach can be used, inter alia, for converting fossil fuels, biomass, and other abundant and waste resources such as CO₂, N₂, O₂, and H₂O to hydrogen, ammonia, valued carbon, functional energy materials, and other chemical products.

Embodiments of the present disclosure are described in detail with reference to the figures wherein like reference numerals identify similar or identical elements. It is to be understood that the disclosed embodiments are merely examples of the disclosure, which may be embodied in various forms. Well-known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to variously employ the present disclosure in virtually any appropriately detailed structure.

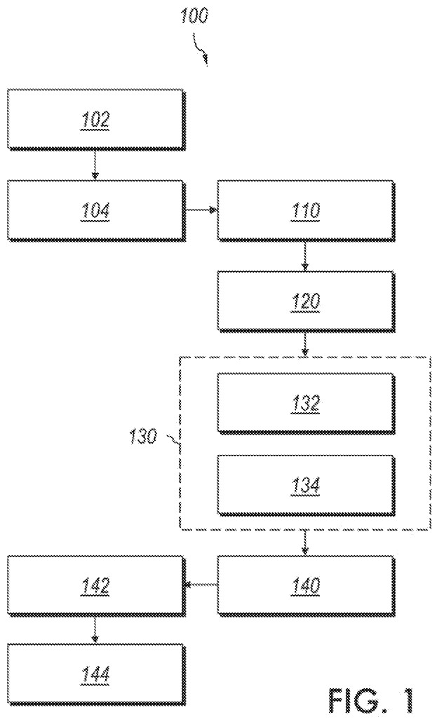

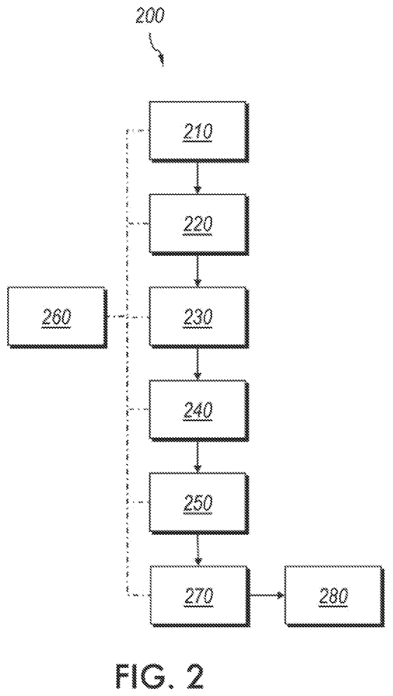

The system and method can be understood with reference to FIGS. 1 and 2. In FIG. 1, a method 100 can be seen. In FIG. 2, a simplified system 200 can be seen.

In some embodiments, the method 100 may include controlling 102 the flow of one or more source gases, aerosols, or mixtures. A controller 260 may be used to, e.g., control the flow of a fluid from one or more sources 210, by controlling pumps, valves, pressures, etc.

In some embodiments, the gas or aerosol may comprise a single raw material, which may be a carbon, nitrogen, oxygen, and/or hydrogen source. In some embodiments, the carbon and/or hydrogen source may comprise a fossil fuel including methane. In some embodiments, the carbon, oxygen and/or hydrogen source is a greenhouse gas. In some embodiments, the carbon nitrogen, oxygen, and/or hydrogen source is water, biogas or biomass.

In some embodiments, the gas or aerosol may comprise a mixture of components. The mixture of components may comprise one or more carbon, nitrogen, oxygen and/or hydrogen sources, and may comprise other components, including diluents or additives.

In some embodiments, the diluent is an inert diluent gas configured to avoid an explosive/ignition region of the mixture. In some embodiments, the diluent is nitrogen, argon, or helium.

In some embodiments, the additive is a secondary carbon, nitrogen, oxygen and/or hydrogen source, such as carbon black, coal, biochar, biomass, biogas, syngas, graphite, coke, structured carbon, carbon dioxide, carbon monoxide, nitrogen, and hydrogen.

In some embodiments, the method 100 may include mixing 104 or combining the one or more sources. This may be done in any appropriate manner, including inline or batch mixing techniques.

In some embodiments, the method 100 may include providing 110 the gas or aerosol to a reaction chamber. By controlling valves, pressures, etc., a controller 260 can allow the fluid to enter the reactor, which is operably connected to the gas or aerosol source 210. The gas or aerosol may enter the reactor into, e.g., a first chamber 220.

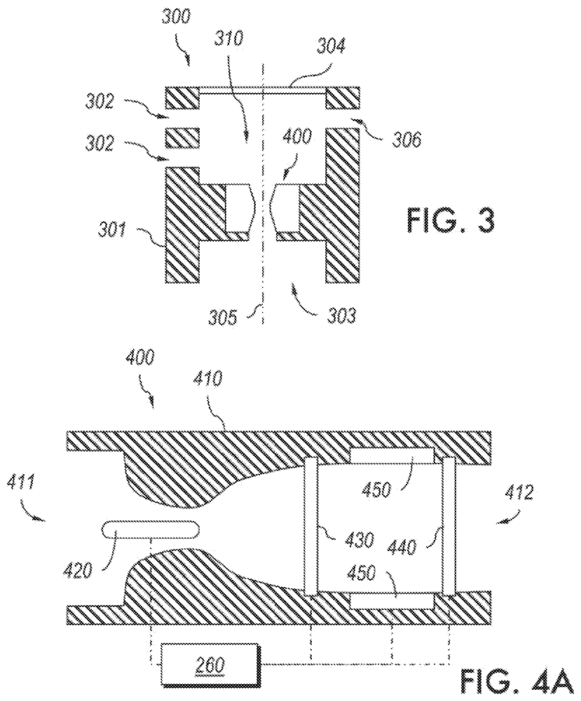

As seen in FIG. 3, a reactor chamber 300 may comprise walls 301 defining one or more inlets 302 and an outlet 303.

In some embodiments, the walls 301 may define a first chamber 310, upstream from a nozzle portion 400. The reactor section 300 is configured to allow the gas or aerosol to flow from inlet 301 through the nozzle portion 400 and out through the outlet 303. In some embodiments, the walls 301 define one or more ports 306 configured to allow a sensor to be operably coupled to the reactor section. In some embodiments, the sensor may be, e.g., a pressure sensor or gauge.

In some embodiments, one or more portions of the reactor section may comprise an optically transparent portion 304, such as an optical window. In some embodiments, the optically transparent portion is configured to allow viewing in an axial direction 305 through the nozzle portion 400.

The method 100 may include generating 120 a non-equilibrium low temperature plasma at a controlled temperature created, e.g., using a programmed electrical heater, which may include electrodes, resistive heating elements, etc. This may involve repeatedly causing a nano-second pulsed discharge through and a pulsed heating on the fluid in the reaction chamber. In FIG. 2, the controller may control a first portion 230 and second portion 240 of the reaction chamber in order to generate the discharges and the programmed electrical heating.

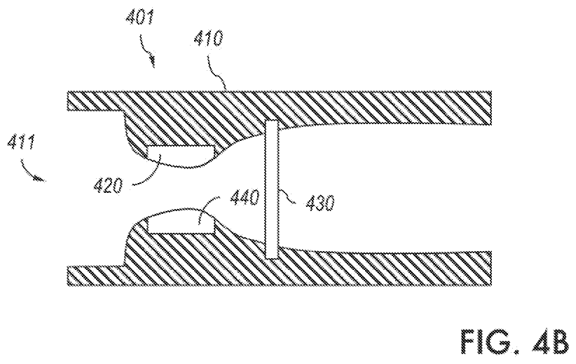

This may be seen in FIG. 4A, where a nozzle section 400 in the downstream of a reaction chamber can be seen. The nozzle section 400 includes walls 410 that define an inlet 411 and an outlet 412. In FIG. 4A, a converging-diverging nozzle is shown, but other configurations may be utilized as appropriate. In FIG. 4A, a controller 260 is operably controlling the discharge and programmed electrical heating for reaction. A second discharge can be added to control the reaction by extending from a first electrode 420 (e.g., an anode) to a second electrode 440 (e.g., a cathode, ground, etc.). The first electrode 420 is placed in the upstream of the converging nozzle, while the second electrode 440 is downstream in the diverging portion of the nozzle taking the advantage of reducing temperature and pressure for discharge. In some embodiments, a gliding arc may be generated between the first electrode and the second electrode. In this case, a controller may use electromagnets 450 to generate a magnetic field and control the location and motion of the gliding arc in the fluid.

However, other configurations are appropriate, as will be understood by those of skill in the art. For example, as seen in FIG. 4B, an alternate nozzle section 401 is shown, where the first electrode and/or programmed electrical heater (420, 440) and second electrode 430 are configured such that at least a portion of the electrodes are within the throat portion of the converging-diverging nozzle.

In some embodiments, the nozzle portion is configured such that prior to entering the nozzle, the fluid is at a pressure greater than 1 atm, and relatively low velocities (i.e., subsonic flow, typically having Mach numbers less than 0.3, 0.2, or 0.1.) In some embodiments, the nozzle portion is configured such that the throat accelerates the fluid to a Mach number of approximately 1. In some embodiments, the nozzle portion is configured such that in the diverging portion of the nozzle, the fluid is accelerated to a Mach number of at least 2, at least 3, or at least 4, with fluid pressures of no more than about half of the pressure in the reactor (e.g. 0.5 atm, 0.4 atm, 0.3 atm, 0.2 atm, or 0.1 atm).

The purpose of the first electrode 420 is to generate a low temperature plasma to activate the chemical reaction at lower temperature. In addition, a programmed electrical heater may be used together with the nonequilibrium plasma in 401 to control the temperature and reaction time. The nozzle and second plasma electrodes (430 and 440) in the nozzle will work together to quench the chemical reaction in non-equilibrium and shift the reaction to increase the yield and selectivity. However, it will be understood by those in the art that the system may include other components, or alternate components, for generating an appropriate low temperature plasma and temperature time history, with little or no experimentation required. For example, in some embodiments, the system could include a microwave or radio frequency (RF) antennas. In some embodiments, direct current (DC) is used to generate the plasma. In some embodiments, alternative current (AC) current is used to generate the plasma.

Referring to FIG. 1, the method 100 may also include reacting 130 the first material to synthesis new materials in a non-equilibrium plasma. In some embodiments, the reacting step 130 includes forming 132 a second material by allowing the first material to react in the reaction chamber at a second temperature, the second temperature being a temperature pulse caused by a programmed electrical heater in at least part of the non-equilibrium low temperature plasma of 130. After the second material is formed, the method may include supersonic quenching 140 to increase the yield of the second material in a supersonic nozzle.

As is seen in FIG. 4A, a third electrode 430 is present, downstream from the first electrode. In some embodiments, it is downstream from the first electrode 420 and upstream from the second electrode 440. In some embodiments, it is downstream from both the first and second electrodes. The third electrode is configured to generate a low temperature plasma, such as via a nanosecond discharge (NSD).

The purpose of this NSD is to create non-equilibrium excitation of the reactant molecules to accelerate the reaction at lower temperature. This may be done by, e.g., controlling the electrical voltage, pulse time, and current applied to the NSD electrode.

In some embodiment, the temperature pulse controlled by the programmed electrical heating has a duration (starting at the time the plasma is a first (low) starting temperature to the time the temperature reaches that first temperature again after reaching a maximum temperature) that is between 10 milliseconds (ms) and 1000 ms. In some embodiments, that duration is between 10 milliseconds and 500 milliseconds. In some embodiments, that duration is between 10 milliseconds and 200 milliseconds.

In some embodiments, the maximum voltage applied to the NSD electrode is from 1 KV, 2 KV, 3 KV, 4 KV, or 5 kV up to 10 kV, 15 kV, 20 kV, or 25 kV, including all combinations and subranges therein. In some embodiments, the maximum voltage applied to the NSD electrode is less than 20 kV. In some embodiments, the maximum voltage applied to the NSD electrode is greater than 25 kV. In some embodiments, the maximum voltage applied to the NSD electrode is less than 1 MV.

In some embodiments, the maximum power used by the NSD electrode is from 50 W to 1000 W. In some embodiments, the maximum power used by the NSD electrode is from 100 W to 500 W. In some embodiments, the average power used by the NSD electrode is from 1 W to 20 W. In some embodiments, the maximum power used by the NSD electrode is from 3 W to 10 W.

In some embodiments, the temperature is controlled dynamically by adjusting the electrical pulse time, voltage, and current sent to the electrode (e.g., the voltage, amperage, frequency, etc.).

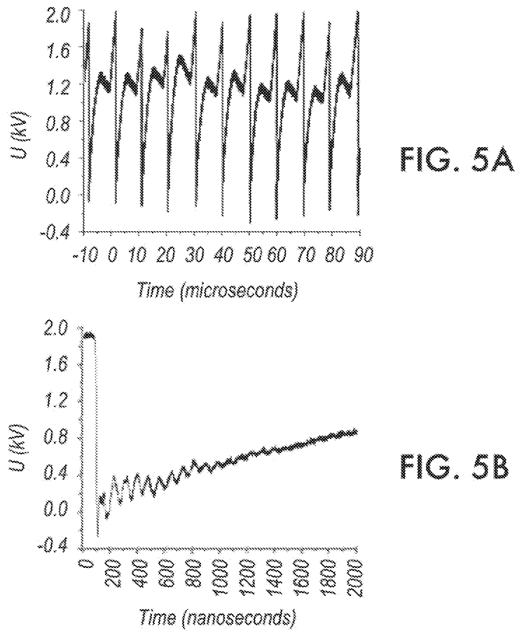

As seen in FIG. 5A, an example graph showing the voltage (U, KV) applied to the electrodes for periodic plasma discharge in methane flow (f=120 kHz, Pₘₑₐₙ=3.5 W). FIG. 5B shows an alternate example graph of voltage (U, kV) applied to electrodes for periodic discharge in methane flow (f=120 kHz, Pₘₐₓ=150 W).

These controlled discharges can be used to control the maximum temperature the fluid is exposed to, while the design of the nozzle and the fluid velocity can control the quenching rate.

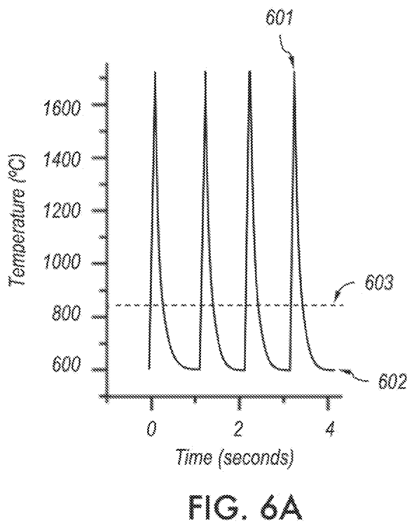

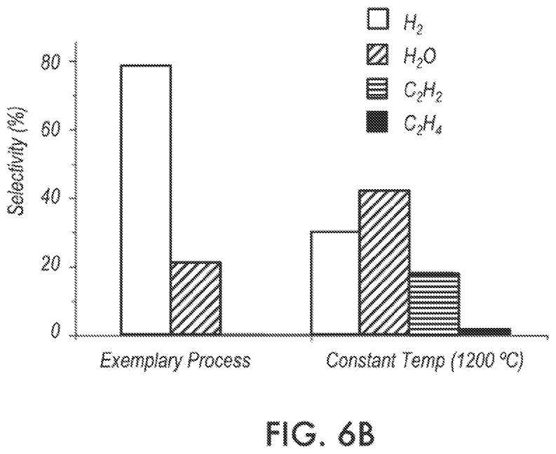

As seen in the example graph shown in FIG. 6A, the temperature of the programmed pulse electrical heating may spike to a maximum temperature 601 (here, a temperature around 1700° C.), before being quenched to a minimum temperature 602 (here, a temperature around 600° C.). In FIG. 6A, an average temperature 603 (here, a temperature around 815° C.) exists.

In some embodiments, the average temperature in the programmed heating is between 450° C. and 850° C. In some embodiments, the average temperature is between 300° C. and 2500° C. In some embodiments, the maximum temperature is from 1000° C., 1250° C., or 1500° C. to 2000° C.

By controlling the plasma discharge properties (plasma voltage, pulse time and current) and the temperature of the low temperature plasma (e.g., by controlling the electrical current flowing to the programmed electrical heater), the maximum temperature and frequency of each pulse (e.g., by controlling the electrical current flowing to the programmed electrical heater), and controlling other aspects of the reactor (e.g., catalysts used, flow rate of various fluids, additives, diluents, etc.), a high level of control over the non-equilibrium reactions occurring in fluid can be achieved.

In some embodiments, the hybrid non-equilibrium low temperature plasmas (e.g. NSD with DC or radio frequency discharge) are used to create controlled electronic and vibrational excitations of the reactant molecules to reduce the activation energy for chemical processing in both gas phase reactions and heterogeneous catalytic reactions.

In some embodiments, the low temperature plasma and programmed heating and quenching are used to reduce synthesis temperature so that the non-equilibrium catalysts will not agglomerate and lose active interfaces and sites at the synthesis temperature.

In some embodiments, the programmed heating and quenching are used to dynamically control the reaction process to enable non-equilibrium chemical synthesis for higher selectivity and yield.

For example, referring to 6B, when methane was used as a source gas, and when the system was controlled to provide the programmed temperature profile as shown in FIG. 6A, with ˜50 ms peak heating time and rapid quenching, the selectivity of the reaction was substantially different than when compared to a more traditional conversion of methane at a constant temperature of 1200° C. When using the disclosed non-equilibrium technique with an average temperature of 815° C., the output from the reactor showed over 95% conversion efficiency, and the output was essentially 80% H₂ and 20% water, with negligibly amounts of C₂H₂ and C₂H₄. A traditional equilibrium process at the same average temperature showed only 10% conversion efficiency, and even at 1200° C., as seen in FIG. 6B, a traditional equilibrium process results in far lower concentration of H₂, and significantly more hydrocarbon (C₂H₂, C₂H₄) production.

Referring to FIG. 1, in some embodiments, during the reaction 130 step, the gas or aerosol is exposed 134 to a catalyst. In some embodiments, non-equilibrium plasma catalysts are used to increase the selectivity and yield via the increase of the active catalyst sites and the coordination between plasma and catalysts.

In some embodiments, the catalyst may be, e.g., fixed-bed catalysts, formed catalyst bodies, catalysts present in dissolved form, catalysts present in suspended or dispersed form, or catalysts present in particulate form (powder, dust): also, two or more different types of catalysts can be combined. In some embodiments, the catalysts may be present, e.g., in or on a plurality of carbon fibers, such as a carbon fiber matrix or felt.

As is known in the art, the choice of catalyst depends on the type of the intended conversion reaction or of the desired reaction products. The catalysts suitable for any particular reaction are known to the person skilled in the art from common technical knowledge. For example, catalysts can be used that are selected from the group comprising metals (e.g., platinum, iron, nickel, etc.), ceramics (e.g., zeolites, aluminum or zirconium oxide), heavy metal acetylides (especially copper acetylide), metal carbonyls and metal carbonyl hydrides.

Even if the conversion of the starting materials, takes place plasma-catalytically, it may occasionally be necessary or advantageous that this reaction be carried out, entirely or partially, in the presence of one or more catalysts. These catalysts can be introduced into the reaction space (plasma chamber), in which the plasma-enhanced conversion takes place: for example, in the form of (nano) particles. These catalyst particles can be recycled: for example, by being separated by a cyclone separator from the gaseous product stream and then fed back into the reaction chamber of the plasma reactor.

In some embodiments, bimetallic non-equilibrium catalysts are used, e.g., to produce surface charge and enhanced electric field. In some embodiments, the bimetallic non-equilibrium catalysts comprise Ni, Co, Cu, Ru, Pt, Fe, or a combination thereof. In some embodiments, the bimetallic non-equilibrium catalysts comprise a ferroelectric perovskite catalyst. In some embodiments, the ferroelectric perovskite catalysts comprise an ABO₃ structure, where A and B are appropriate cations.

In some embodiments, the catalyst may comprise a plasmonic nanocatalysts. Plasmonic nanocatalysts may be used to, e.g., create plasmon enhanced electric field and plasmon enhanced catalysis. In some embodiments, the plasmonic nanocatalysts comprise Au. Ag, Cu, Ru, or a combination thereof.

In some embodiments, plasma chemistry and properties, non-equilibrium plasma catalysts, programed heating temperature and cycle, gas phase reaction time, and supersonic reaction quenching and shifting equilibrium are optimized to increase the yield, selectivity, and carbon morphology of an output product stream.

Referring to FIG. 1, in some embodiments, the method includes collecting 142 and/or separating 144 the output from the reactor, according to known techniques. In some embodiments, any non-reacted material is recycled and reprocessed through the reactor again.

In some embodiments, the output from the reactor is sent to, e.g., a vacuum chamber or vacuum line 250, and/or one or more filters 270. The filtered output may be provided to, e.g., a gas chromatograph 280 or other analytical instrumentation.

Rapidly expanding renewable electricity production from wind and solar and its strong intermittency as well as regional dependence provide significant opportunities to use electrical heating and low temperature plasma for distributed production of hydrogen, ammonia, valued carbon, fuels, and other chemicals from fossil fuels, biomass, and other abundant or waste resources. These opportunities are critical to support decarbonization in energy and chemical processing sectors since conventional methods to produce, e.g., hydrogen, ammonia, chemicals, high-value energy materials from fossil fuels are not only energy and carbon intensive but also based on high pressure equilibrium thermal chemical processes and difficult to be scaled down for distributed chemical processing. Thus, in some embodiments, renewable electricity is used for the programmed heating and plasma activation.

An important feature of the disclosed approach is to realize an efficient and high selectivity synthesis method of chemicals and materials by using non-chemical equilibrium, non-equilibrium multi-functional catalysts, and non-equilibrium of excited states via active control of molecule excitation by low temperature hybrid plasma, dynamics of chemical reactions by programed heating and supersonic quenching, and the design of non-equilibrium catalysts by thermal shocks and plasma coupling to enable distributed and electrified chemical synthesis of hydrogen, ammonia, valued carbon and other chemical products at atmospheric conditions. As such, the disclosed approach will enable distributed, electrified, low-carbon, and non-equilibrium chemical and material synthesis using renewable electricity, fossil fuels, biomass, and other abundant or waste resources.

The efficiency can be seen by considering the energy required to produce hydrogen using the disclosed technique to the energy required to produce hydrogen by electrolysis or the energy consumed by hydrogen combustion. When a disclosed system was used, quenching occurred at a Mach number of 3, and a gas chromatograph was used to determine the rate of hydrogen produced, it can be readily shown that the energy required for hydrogen production under those conditions is 28 kWh/kg of hydrogen. When quenching was adjusted, and the Mach number was reduced to 1, it was determined that the energy required for hydrogen production rose to 43 kWh/kg. The energy of hydrogen combustion (E_{c}) is approximately 39 kWh/kg. The energy required to product hydrogen via modern electrolysis techniques is currently approximately 72 kWh/kg. Thus, it is clear that the disclosed method can generate hydrogen using less energy than the energy of hydrogen combustion.

### Example 1

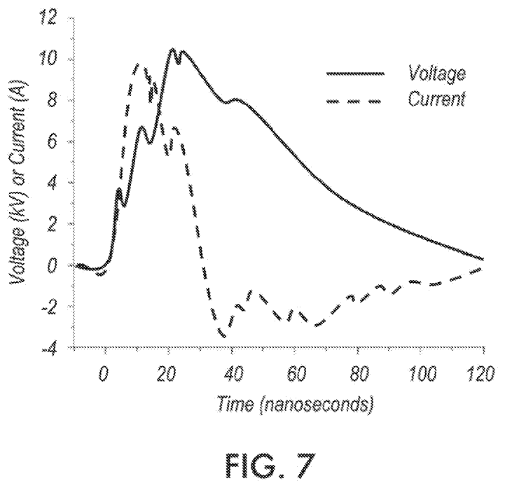

A converging-diverging nozzle reactor was created, with a nozzle diameter do of 1.3 mm, a nozzle exit de of 3.2 mm, and a nozzle length of 9 mm. The residence time t was configured to be 8 microseconds, and the nozzle had a Mach number of 3. During operating, the feed gas was provided at 293 K, 760 torr. In the nozzle throat, where the NSD electrode was positioned, the average temperature reached 2500 K, at a pressure of 410 torr. In the supersonic diverging portion of the nozzle, the temperature was 120 K, at a pressure of 20 torr. The voltage and current profile of a pulse sent to the NSD electrode can be seen in FIG. 7.

A nanosecond high voltage pulse leads to effective ionization and dissociation of the gas in the discharge gap/channel. The typical diameter of the plasma channel under flow conditions in the nozzle throat is 0.6 mm with a throat diameter of 1.3 mm, which provides a significant degree of gas dissociation in the flow and its rapid cooling. The electron number density of a nanosecond discharge is nₑ˜10¹⁶ cm⁻³, which leads to a significant overheating of the gas in the channel after plasma recombination to T=4300 K. This temperature is sufficient to obtain a complete dissociation of methane in the discharge. Subsequent rapid cooling leads to the formation of a nonequilibrium composition of products. It will be understood that the gas from the discharge gap is cooled in two processes: first, when the gas moves along the nozzle, and second, during the gas-dynamic expansion of the plasma into the surrounding gas.

Those skilled in the art will recognize or be able to ascertain using no more than routine experimentation many equivalents to the specific embodiments of the invention described herein. Such equivalents are intended to be encompassed by the following claims.

What is claimed:

1. A method for non-equilibrium chemical and materials processing, comprising:
providing a fluid comprising a first material to a reaction chamber;
generating a non-equilibrium low temperature plasma at a first temperature;
forming a second material by allowing the first material to react in the reaction chamber at a second temperature, the second temperature being a temperature pulse created by programmed electrical heating in at least part of the non-equilibrium low temperature plasma; and
quenching the second material in a supersonic nozzle.

2. The method according to claim 1, wherein the non-equilibrium low temperature plasma is generated with programmed electrical heating.

3. The method according to claim 1, wherein the non-equilibrium low temperature plasma is generated without programmed electrical heating.

4. The method according to claim 1, wherein the second material is quenched in the supersonic nozzle with additional plasma discharge.

5. The method according to claim 1, wherein the second material is quenched in the supersonic nozzle without additional plasma discharge.

6. The method according to claim 1, wherein the first material is configured to react with a non-equilibrium multifunctional plasma catalyst in the reaction chamber, the non-equilibrium multifunctional plasma catalyst configured to the selectivity and yield via the increase of the active catalyst sites and the coordination between plasma and catalysts.

7. The method according to claim 6, wherein the non-equilibrium multifunctional plasma catalyst is a bimetallic non-equilibrium catalyst.

8. The method according to claim 7, wherein the bimetallic non-equilibrium catalyst is used to produce surface charge and an enhanced electric field.

9. The method according to claim 8, wherein the bimetallic non-equilibrium catalyst comprises Ni, Co, Cu, Ru, Pt, Fe, or a combination thereof.

10. The method according to claim 8, wherein the bimetallic non-equilibrium catalyst comprises a ferroelectric perovskite catalyst.

11. The method according to claim 10, wherein the ferroelectric perovskite catalyst has an ABO; structure where A and B are appropriate cations.

12. The method according to claim 6, wherein the non-equilibrium multifunctional plasma catalyst is a plasmonic nanocatalyst.

13. The method according to claim 12, wherein the plasmonic nanocatalyst is used to create a plasmon enhanced electric field and plasmon enhanced catalysis.

14. The method according to claim 12, wherein the plasmonic nanocatalyst comprises Au, Ag, Cu, Ru, or a combination thereof.

15. The method according to claim 6, wherein the synthesis temperature is controlled by the programed electrical heating such that the non-equilibrium catalysts will not agglomerate and lose active interfaces and sites at the synthesis temperature.

16. The method according to claim 1, further comprising dynamically adjusting the synthesis temperature and non-equilibrium activation of the reactants by plasma and pulsed heating.

17. A system for non-equilibrium chemical and materials processing, comprising:
a reaction chamber operably couplable to a source of a first material, the reaction chamber comprising a nano-second discharge (NSD) electrode, programmed pulse electrical heater, and a supersonic quenching nozzle; and
a controller configured to generate a non-equilibrium plasma and utilize a programmed electrical heating element to control the temperature time history in the downstream of the NSD to allow the first material to react and form a second material in a non-equilibrium process, after which the product materials is quenched as it passes through the supersonic quenching nozzle.

18. The system according to claim 17, wherein the non-equilibrium plasma is generated by a nano-second discharge at the NSD electrode.

19. The system according to claim 17, further comprising a non-equilibrium multifunctional plasma catalyst in the reaction chamber.

20. The system according to claim 18, wherein a plurality of carbon fibers support the non-equilibrium multifunctional plasma catalyst within the reaction chamber.
